(19) United States
(12) Patent Application Publication
(10) Pub. No.: US 2008/0128355 A1
(43) Pub. Date: Jun. 5, 2008

(54) FILTRATION APPARATUS AND METHOD

(76) Inventors: Derek Lee Watkins, Elizabethtown, KY (US); Timothy Dale Worthington, Crestwood, KY (US); Ronald Scott Tarr, Louisville, KY (US)

Correspondence Address: GENERAL ELECTRIC CO.;GLOBAL PATENT OPERATION, 187 Danbury Road, Suite 204, Wilton, CT, 06897-4122, US

(21) Appl. No.: 11/565,238

(22) Filed: Nov. 30, 2006

(51) Int. Cl. C02F 1/44

(52) U.S. Cl. 210/637; 210/137

(57) ABSTRACT

A method of delivering filtered water includes exerting a first pressure against a first side of a diaphragm. A second pressure is exerted, with the filtered water, against a second side of the diaphragm. The second pressure is eliminated on the second side of the diaphragm such that the filtered water flows away from the diaphragm at the first pressure exerted against the first side of the diaphragm.

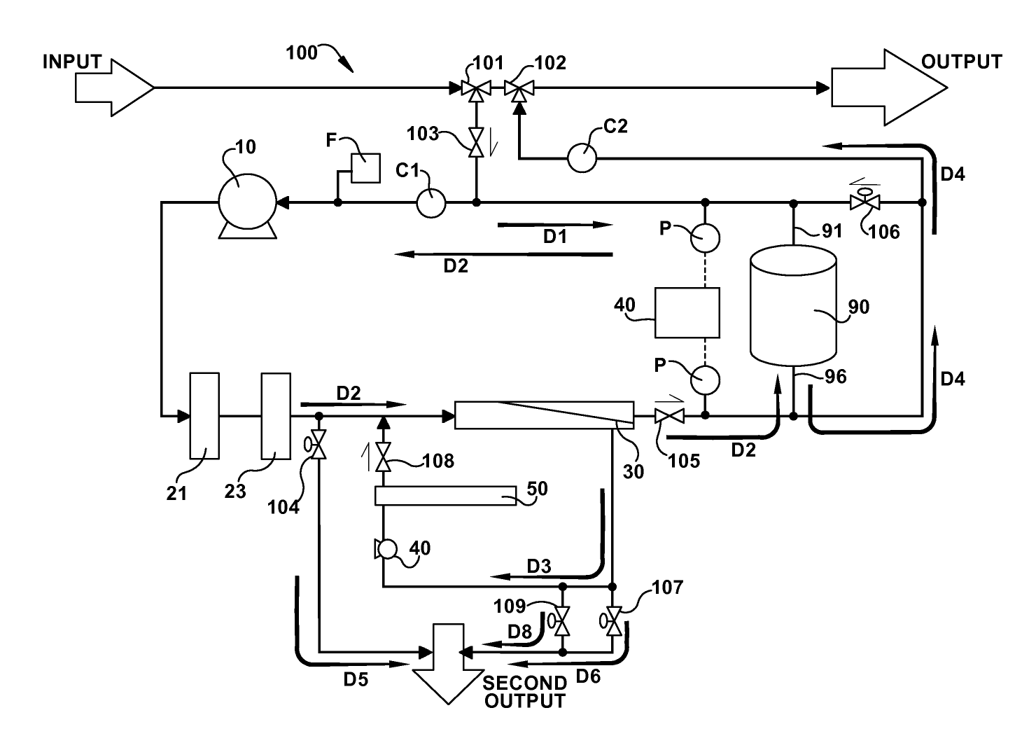

### BACKGROUND OF THE INVENTION

The described technology relates to a filtration apparatus, such as a water filtration apparatus, and a corresponding method.

Magnesium and calcium ions often are present in the water. These ions cause numerous disadvantages. For example, the ions react with soaps and detergents, reducing lather production, reducing a cleaning effect, and forming an unsightly precipitate. Further, the calcium and magnesium ions from calcium and magnesium carbonates, referred to as scale, which adhere to surfaces of pipes of a plumbing system through which the water flows and a water heating system that heats the water. The scale restricts water flow through the pipes, and reduces the transfer of heat by the water heating system to the water.

It is known to use a water softener to remove calcium and magnesium ions form the water, by replacing the calcium and magnesium ions with sodium ions. The use of the known water softener results in numerous disadvantages, however. For example, consumption of the softened water may be avoided because of the additional sodium in the water. Further, the known water softener must be periodically regenerated by the introduction of a concentrated brine solution. However, most of the sodium in the brine solution is almost immediately flushed out of the water softener and released into a sewer or a cesspool, which causes negative environmental results. Thus, disposal of the brine solution often is regulated, thereby complicating continuous use of the conventional water softener.

### BRIEF DESCRIPTION OF EMBODIMENTS OF THE INVENTION

As described herein, embodiments of the invention overcome one or more of the above or other disadvantages known in the art.

In an embodiment, a method of delivering filtered water includes exerting a first pressure against a first side of a diaphragm. A second pressure is exerted, with the filtered water, against a second side of the diaphragm. The second pressure is eliminated on the second side of the diaphragm such that the filtered water flows away from the diaphragm at the first pressure exerted against the first side of the diaphragm.

In another embodiment, a method of filtering water includes flowing unfiltered water from an input to a pump to increase a pressure of the water, flowing the unfiltered water from the pump to a filter to remove contaminants from the water, and flowing the filtered water from the filter to a reverse osmosis system to purify the water. The purified water flows from the reverse osmosis system to a first inlet of a storage tank, and flows from the first inlet of the storage tank to an output.

### BRIEF DESCRIPTION OF THE DRAWING

The following figure, which is a schematic view of a filtration apparatus, illustrates examples of embodiments of the invention. The figure is described in detail below.

### DETAILED DESCRIPTION OF EMBODIMENTS OF THE INVENTION

Embodiments of the invention are described below, with reference to the figure, which is a schematic view of a filtration apparatus in accordance with the present invention. As shown in the figure, the filtration apparatus 100 is disposed between an INPUT and a FIRST OUTPUT, the INPUT being an entrance into the filtration apparatus 100, and the FIRST OUTPUT being an exit from the filtration apparatus 100. Non-limiting examples of the INPUT include a municipal water system (sometimes referred to as a city water system) and a well water system. Non-limiting examples of the FIRST OUTPUT include a portion of a plumbing system, such as of a residential, commercial or industrial building. It is to be understood, however, that the INPUT and/or the FIRST OUTPUT are not limited to any of the specific examples discussed above. Rather, the filtration apparatus 100 can be disposed between any entrance into the filtration apparatus 100 and any exit from the filtration apparatus 100. It is contemplated that the water flowing into the INPUT from the municipal water system has a pressure of about 80 PSI (551.6 kPa), and a volumetric flow rate of about 5 gallons/min (18.9 L/min).

The filtration apparatus 100 includes first and second valves 101 and 102. It is to be understood that the first and second valves 101 and 102 are configured to be positioned such that the water flowing into the filtration apparatus 100 through the INPUT (i) flows through other components of the filtration apparatus 100, such as before flowing to the FIRST OUTPUT, (ii) flows directly to the FIRST OUTPUT without flowing through other components of the filtration system 100, or (iii) is prevented from flowing to the FIRST OUTPUT. It is contemplated that the first and second valves 101 and 102 are manual bypass valves. It is also to be understood, however, that the first and second valves 101 and 102 are not required to be manual bypass valves, and the use of the first and second valves 101 and 102 is not required in the filtration apparatus 100.

In order to purify the water flowing into the INPUT and to deliver the purified water to the FIRST OUTPUT, the water flows from the first valve 101 to a third valve 103. It is contemplated that the third valve 103 is a check valve, permitting the water only to flow from the first valve 101 and preventing the water from flowing back to the first valve 101. It is to be understood, however, that the third valve 103 is not required to be a check valve, and the use of the third valve 103 is not required in the filtration apparatus 100.

The water flowing from the third valve 103 flows in first and second directions D1 and D2. Specifically, the water flowing in the first direction D1 flows from the third valve 103 to a non-purified water inlet 91 of a water holding tank 90. The water holding tank 90 includes a liquid impermeable diaphragm disposed in an interior of a housing. By this arrangement, the interior of the water holding tank 90 is filled to capacity with the water (later referred to as non-purified water, as contaminants, sediment or other impurities in the water are not removed form the water by the filtration apparatus 100) having a pressure equal to a pressure of the water flowing into the INPUT, the water pressing (i.e., exerting pressure) against a non-purified-water side of the diaphragm. As stated above, it is contemplated that the water flowing into the INPUT from the municipal water system has a pressure of about 80 PSI (551.6 kPa), and that the volume of the interior of the water holding tank 90 is about 80 gallons (302.8 liters).

The water flowing in the second direction D2 flows from the third valve 103 to a first conductivity meter C1 and a flow meter F. The first conductivity meter C1 is configured to measure an amount of dissolved particles in the water flowing into the filtration apparatus 100 from the INPUT, while the flow meter F is configured to measure a volume and/or mass flow rate of the water flowing into the filtration apparatus 100 from the INPUT. It is to be understood that the first conductivity meter C1 and the flow meter F are not required to be separate from one another. For example, a single meter can be used to measure both the amount of dissolved particles and/or the volume and/or mass flow rate. It also is to be understood that each of the first conductivity meter C1 and the flow meter F is not required to be used in the filtration apparatus 100, that relative positions of these meters can be altered, and that one, none, or other meters can be used in the filtration apparatus 100.

The water flowing in the second direction D2 flows from the first conductivity meter C1 and the flow meter F to a booster pump 10. The booster pump 10 is configured to boost the pressure of the water flowing in the second direction. As stated above, it is contemplated that the water flowing into the INPUT from the municipal water system has a pressure of about 80 PSI (551.6 kPa). It further is contemplated that the booster pump 10 increases the pressure of the water by about 120 PSI (827.4 kPa), such that the water flowing from the booster pump 10 in the second direction D2 has a pressure of about 200 PSI (1.4 mPa).

The water flowing in the second direction D2 flows from the booster pump 10 to the first and second filters 21 and 23. The first filter 21 is configured to remove contaminants, sediment and/or other impurities from the water flowing in the filtration apparatus 100. The second filter 23 is configured to one or both of neutralize chlorine in the water and to eradicate bacteria in the water. For example, a carbon material can be used to neutralize the chlorine in the water, and a silver material can be used to eradicate the bacteria in the water. It is to be understood that the first and second filters 21 and 23 are not required to be separate from one another. For example, a single filter can be used to remove contaminants, sediment and/or other impurities, to neutralize chlorine and to eradicate bacteria. It also is to be understood that the second filter 23 is not required to use the carbon material to neutralize chlorine and/or to use the silver material to eradicate bacteria. It further is to be understood that each of the first and second filters 21 and 23 is not required to be used in the filtration apparatus 100, that relative positions of these filters can be altered, and that one, none, or other filters can be used in the filtration apparatus 100.

The water flowing in the second direction D2 flows from the filters 21 and 23 to a reverse osmosis system 30, which includes a membrane, when a fourth valve 104 is appropriately positioned. Use of the reverse osmosis system 30 to purify the water through removal of contaminants including magnesium and/or calcium ions, is known to those of ordinary skill in the art, and therefore details of this use are omitted. It is contemplated that about 75% of the water flowing to the reverse osmosis system 30 in fact flows partially through the reverse osmosis system 30, is not purified, and flows in a third direction D3. The remaining about 25% of the water flowing to the reverse osmosis water 30 flows completely through the reverse osmosis system 30, is purified, and flows in the second direction D2. It is contemplated that the purified water flowing completely through the reverse osmosis system 30 undergoes a pressure decrease of almost about 120 PSI (827.4 kPa), such that the purified water flowing in the second direction D2 has a pressure of slightly greater than about 80 PSI (551.6 kPa). It further is contemplated that the fourth valve 104 is a manual bypass valve. It also is to be understood, however, that the fourth valve 104 is not required to be a manual bypass valve, and the use of the fourth valve 104 is not required in the filtration apparatus 100. In alternate embodiments of the invention, 100% of the water flowing to the reverse osmosis system 30 flows completely through the reverse osmosis system 30 and is purified.

The water flowing in the second direction D2 flows from the reverse osmosis system 30 to a fifth valve 105. It is contemplated that the fifth valve 105 is a check valve, permitting the water only to flow into the second direction D2 from the reverse osmosis system 30 and preventing the water from flowing back to the reverse osmosis system 30. It is to be understood, however, that fifth valve 105 is not required to be a check valve, and the use of the fifth valve 105 is not required in the filtration apparatus 100.

The purified water flowing in the second direction D2 flows from the fifth valve 105 to a purified water inlet 96 of the water holding tank 90. As stated above, it is contemplated that the purified water has a pressure of slightly greater than about 80 PSI (551.6 kPa), which is greater than the pressure of the water flowing into the non-purified water inlet 91 of the water holding tank 90. By this arrangement, the water holding tank 90 is filled to capacity with the purified water, the purified water pressing against a purified-water side of the diaphragm in the housing of the water holding tank 90, while the non-purified water flows out of the water holding tank 90 through the non-purified water inlet 91. Thus, the diaphragm isolates or separates the purified water from the non-purified water. The non-purified water flows in the direction D2 to the first conductivity meter C1, the flow meter F and the booster pump 10 in the same manner described above.

The volume of the interior of the water holding tank 90 is now filled with the purified water. As discussed above, it is contemplated that the volume of the water holding tank 90 is about 80 gallons (302.8 liters). The non-purified water continues to press (i.e., exert pressure) against the non-purified-water side of the diaphragm of the water holding tank 90 at the pressure of the non-purified water flowing into the INPUT, such as for example at about 80 PSI (551.6 kPa). Because of this arrangement, the water holding tank 90 is often referred to as a “water-on-water” tank. Thus, it is to be understood that even when the booster pump 10 is deenergized (i.e., not operating), the filtration apparatus 100 is configured to deliver the purified water at a same pressure as the pressure of the water flowing into the INPUT of the filtration apparatus 100, such as for example at about 80 PSI (551.6 kPa), as long as there is any volume of purified water in the water holding tank 90. This delivery occurs when the pressure exerted by the purified water on the purified-water-side of the diaphragm is decreased or eliminated, such as by opening a tap or faucet connected to the FIRST OUTPUT.

By this arrangement, energization (i.e., operation) of the booster pump 10 is not required except to fill the interior of the water holding tank 90, such as when the volume of the purified water in the interior of the water holding tank 90 falls below a predetermined minimum volume. As a result, life of the booster pump 10 is greatly extended, as it is estimated that when the filter apparatus 100 is utilized in a typical residential building, the booster pump 10 operates two or three times per day, rather than each time purified water is delivered by the filtration apparatus 100. The life of the booster pump 10 is still further extended by disposing the booster pump 10 upstream of one or more of the filter 21, the filter 23 and the reverse osmosis system 30. Specifically, the booster pump 10 is prevented from operating when receiving less than an amount of the water adequate to prevent the booster pump 10 from being damaged, such as if the filter 21, filter 23 or reverse osmosis system 30 were clogged and the booster pump 10 were disposed downstream of the clogged filter 21, filter 23 or reverse osmosis system 30.

During delivery of the purified water from the water holding tank 90, the purified water flows in a fourth direction D4 to a second conductivity meter C2. The second conductivity meter C2 is configured to measure an amount of dissolved particles in the purified water. It is to be understood that the second conductivity meter C2 is not required to be used in the filtration apparatus 100, and that no meter or another meter can be used in the filtration apparatus 100.

The purified water flowing in the fourth direction D4 from the second conductivity meter C2 flows through the second valve 102, and ultimately to the FIRST OUTPUT. As discussed above, by this arrangement purified water is delivered to the FIRST OUTPUT at the same pressure as the pressure of the water flowing into the INPUT of the filtration apparatus 100, as the water flowing into the input is used to pressurize the purified water.

The filtration apparatus 100 can include a sixth valve 106 disposed such that when the pressure of the purified water flowing in the fourth direction D4 exceeds a predetermined maximum pressure, the purified water is prevented from flowing at full pressure to the FIRST OUTPUT. It is contemplated that the sixth valve 106 is a pressure relief valve disposed such that when the pressure of the purified water exceeds a maximum pressure less than about 100 PSI (689.5 kPa), a maximum pressure for which plumbing systems in most homes are rated, the water flows through the sixth valve 106 in the second direction D2 to the conductivity meter C1, the flow meter F and the booster pump 10 in the manner described above, rather than to the FIRST OUTPUT.

It is contemplated that under some set of operating conditions, the first and/or second filters 21 and 23 are flushed. For example, when the second filter 23 is initially disposed in the filtration apparatus 100, and the second filter 23 uses the carbon material, the second filter 23 can include carbon fines that should be removed. Further, after extended operation of the filtration apparatus 100, when the first and second filters 21 and 23 are full of contaminants, sediment and/or impurities, the contaminants, sediment or impurities should be removed. Under these operating conditions, the fourth valve 104 is positioned such that the water flowing through the first and second filters 21 and 23 flows in a fifth direction D5, to a SECOND OUTPUT from the filtration apparatus 100 which is separate from the FIRST OUTPUT. Non-limiting examples of the SECOND OUTPUT include a sewer system and a cesspool system. It is to be understood, however, that the SECOND OUTPUT is not limited to any of the specific examples discussed above. Rather, the SECOND OUTPUT can be any exit from the filtration apparatus 100 separate from the FIRST OUTPUT.

As discussed above, it is contemplated that about 75% of the water flowing to the reverse osmosis system 30 flows partially through the reverse osmosis system 30, is not purified by the removal of the contaminants, and flows in the third direction D3. It is contemplated that under some set of operation conditions, the reverse osmosis system 30 is flushed. For example, when the reverse osmosis system 30 is initially disposed in the filtration apparatus 100, the reverse osmosis system 30 can include contaminants that should be removed. Further, after extended operation of the filtration apparatus 100, when the reverse osmosis system 30 is full of contaminants, sediment and/or impurities, the contaminants, sediment or impurities should be removed. Under these operating conditions, a seventh valve 107 is positioned such that the water flowing partially through the reverse osmosis system 30 flows in a sixth direction D6, to the SECOND OUTPUT. Alternately, the water flowing partially through the reverse osmosis system 30 flows to an output that is separate from the FIRST OUTPUT and from the SECOND OUTPUT.

It is also contemplated, however, that under some set of operating conditions, it is desired to recirculate a least a portion of the about 75% of the water that flows partially through the reverse osmosis system 30. Under these operating conditions, the seventh valve 107 is appropriately positioned, and the recirculated water continues to flow in the third direction D3, to the recirculation pump 40. The recirculation pump 40 is configured to boost the pressure of the recirculated water flowing in the third direction D3. It is contemplated that the recirculated water that flows partially through the reverse osmosis system 30 undergoes a pressure decrease of about 5 PSI (34.5 kPa). Thus, it further is contemplated that the recirculation pump 40 increases the pressure of the recirculated water by about 5 PSI (34.5 kPa), such that the recirculated water flowing from the recirculation pump 40 in the third direction D3 has a pressure about equal to a pressure of the water flowing to the reverse osmosis systems 30 from the first and second filters 21 and 23.

Before the recirculated water is recirculated back to the reverse osmosis system 30, the recirculated water flowing in the third direction D3 flows through a scale inhibitor 50 and an eighth valve 108. The scale inhibitor 90 is configured to prevent the formation of scale on components of the filtration apparatus 100, such as on the reverse osmosis system 30. It is contemplated that the eighth valve 108 is a check valve, permitting the water only to flow into the third direction D3 from the recirculation pump 40 and preventing the water from flowing back to the recirculation pump 40. It is to be understood, however, that the eighth valve 108 is not required to be a check valve. It further is to be understood that each of the scale inhibitor 50 and the eighth valve 108 is not required to be used in the filtration apparatus 100, that relative positions of these components can be altered, and that one, none, or other scale inhibitors and/or valves can be used in the filtration apparatus 100.

It is to be understood that as the recirculated water is continuously recirculated to flow only partially through the reverse osmosis system 30, a concentration of the impurities in the recirculated water increases. To prevent reverse osmosis system 30 from becoming blocked by these impurities, a portion of the water that would otherwise be recirculated is prevented form flowing back to the reverse osmosis system 30. Specifically, a ninth valve 109 is used to flow at least a portion of this water in an eighth direction D8, to the SECOND OUTPUT. Alternately, the portion of the water flows to an output that is separate from the FIRST OUTPUT and from the SECOND OUTPUT.

It is contemplated that the ninth valve 109 is a bleed valve, such as a needle valve. It is also contemplated that about 10% of the water that would otherwise be recirculated flows to the SECOND OUTPUT through the ninth valve 109, while the remaining about 90% of the water continues to be recirculated. Thus, for example, when the volumetric flow rate of the water into the INPUT is about 5 gallons/min (18.9 L/min), about 0.5 gallons/min (1.9 L/min) flows to the second output.

The filtration apparatus 100 alternately includes a switching device 40. In embodiments of the invention, the switching device 40 includes pressure sensors P that are configured to measure pressure on upstream and downstream sides of the booster pump 10. The switching device 40 is configured to deactivate the booster pump 10 when the pressure of the purified water on the downstream side of the booster pump 10, purified by the reverse osmosis system 30, exceeds by a predetermined amount the pressure of the non-purified water on the upstream side of the booster pump 10. As discussed above, it is contemplated that the non-purified water from the municipal water system has a pressure of about 80 PSI (551.6 kPa), while the purified water flowing through the reverse osmosis system 30 has a pressure of slightly greater than about 80 PSI (551.6 kPa). It is further contemplated that the switching device 40 is configured to deactivate the booster pump 10 when the pressure of the purified water on the downstream side of the booster pump 10 exceeds the pressure of the non-purified water on the upstream side of the booster pump 10 by about 7 PSI (48.3 kPa). By this arrangement, the filtration apparatus 100 is prevented from operating the booster pump 10 when the pressure of the purified water is substantially higher than the pressure of the water flowing into the INPUT, and the purified water is prevented from being delivered to the FIRST OUTPUT at a pressure substantially higher than the pressure of the water flowing into the INPUT.

This written description uses examples to disclose embodiments of the invention, including the best mode, and also to enable a person or ordinary skill in the art to make and use embodiments of the invention. It is to be understood that the patentable scope of embodiments of the invention is defined by the claims, and can include additional components occurring to those skilled in the art. Such other arrangements are understood to be within the scope of the claims.

1. A method of delivering filtered water, comprising:
exerting a first pressure against a first side of a diaphragm;
exerting a second pressure, with the filtered water, against a second side of the diaphragm; and
reducing the second pressure on the second side of the diaphragm such that the filtered water flows away from the diaphragm at the first pressure exerted against the first side of the diaphragm.

2. The method of claim 1, further comprising:
flowing water through a filter or a system to produce the filtered water.

3. The method of claim 2, wherein exerting the second pressure comprises flowing the filtered water into a storage tank in which the diaphragm is disposed.

4. The method of claim 3, wherein exerting the first pressure comprises exerting the first pressure, with unfiltered water, against the first side of the diaphragm.

5. The method of claim 4, wherein flowing the water through the filter or system comprises pumping the unfiltered water through the filter or system to produce the filtered water.

6. The method of claim 3, wherein exerting the first pressure comprises exerting the first pressure, with unfiltered water, against the first side of the diaphragm, and wherein flowing the water through the filter or system comprises pumping the unfiltered water through the filter or system to produce the filtered water, the pumping increasing a pressure of the unfiltered water.

7. The method of claim 6, wherein flowing the water comprises flowing the unfiltered water through the filter or the system to remove impurities in the water.

8. The method of claim 7, wherein flowing the water comprises flowing the unfiltered water through the filter to remove contaminants, to eradicate bacteria or to neutralize chlorine or flowing the unfiltered water through the system, which is a reverse osmosis system.

9. The method of claim 8, wherein flowing the water comprises flowing the unfiltered water through the reverse osmosis system.

10. The method of claim 9, wherein flowing the water comprises flowing a portion of the unfiltered water completely through the reverse osmosis system to provide the filtered water and flowing another portion of the unfiltered water only partially through the reverse osmosis system.

11. The method of claim 10, further comprising:
recirculating back through the reverse osmosis system the another portion of the unfiltered water that flows partially through the reverse osmosis system.

12. The method of claim 11, further comprising:
deenergizing the pump when the second pressure exceeds the first pressure by a predetermined amount.

13. A method of filtering water, comprising:
flowing unfiltered water from an input to a pump to increase a pressure of the water;
flowing the unfiltered water from the pump to a filter to remove contaminants from the water;
flowing the filtered water from the filter to a reverse osmosis system to purify the water;
flowing the purified water from the reverse osmosis system into a first inlet of a storage tank; and
flowing the purified water from the first inlet of the storage tank to an output.

14. The method of claim 13, wherein flowing the unfiltered water from the input comprises flowing the unfiltered water from the input to a second inlet of the storage tank, the storage tank comprising a diaphragm to isolate the unfiltered water from the filtered water.

15. The method of claim 14, further comprising:
increasing a pressure of the unfiltered water with the pump.

16. The method of claim 15, wherein flowing the filtered water comprises flowing a portion of the filtered water completely through the reverse osmosis system to purify the water and flowing another portion of the filtered water only partially through the reverse osmosis system.

17. The method of claim 16, further comprising:
recirculating back through the reverse osmosis system the another portion of the filtered water that flows only partially through the reverse osmosis system.

18. A water filtration apparatus, comprising:
a water input configured to receive unfiltered water;
a pump disposed downstream of the water input, the pump configured to increase a pressure of the unfiltered water;
a filter disposed downstream of the pump;
a reverse osmosis system disposed downstream of the pump;
a water storage tank disposed downstream of the filter and the reverse osmosis system, the water storage tank configured to store on a first side of a diaphragm the unfiltered water and to store on a second side of the diaphragm filtered water.

19. The apparatus of claim 18, further comprising:
a water output disposed downstream of the water storage tank, the output configured to deliver the purified water.

20. The apparatus of claim 19, further comprising:
a recirculation path configured to receive filtered water than only flow partially through the reverse osmosis system and to recirculate back to the reverse osmosis system the filtered water that only flows partially through the system.
